(19) United States
(12) Patent Application Publication
(10) Pub. No.: US 2025/0024408 A1
(43) Pub. Date: Jan. 16, 2025

(54) WI-FI POSITIONING METHOD AND SYSTEM

(71) Applicant: ESPRESSIF SYSTEMS (SHANGHAI) CO., LTD., Shanghai (CN)

(72) Inventors: Xu WANG, Shanghai (CN); Rui ZHAN, Shanghai (CN); Benjamin Lei MUNG, Shanghai (CN); Yunsheng FU, Shanghai (CN)

(21) Appl. No.: 18/575,786

(22) PCT Filed: Jun. 30, 2022
(86) PCT No.: PCT/CN2022/102585

§ 371 Date: Sep. 16, 2024

(30) Foreign Application Priority Data
Jun. 30, 2021 (CN) 202110748377.5

(51) Int. Cl. H04W 64/00; H04B 7/06; H04W 72/0446; H04W 72/0453

(52) U.S. Cl. CPC H04W 64/00; H04B 7/0626; H04W 72/0446; H04W 72/0453

(57) ABSTRACT

A Wi-Fi positioning method and system. The method comprises: generating and sending, by an access point device, a channel status indication frame; receiving, by a device to be positioned, the channel status indication frame; generating, by the device to be positioned a frequency sweep information frame according to a current channel status indicated by the channel status indication frame, the frequency sweep information frame comprising time-frequency domain resource indication information, where the time-frequency domain resource indication information specifies the time-frequency domain resource block; sending, by the device to be positioned, the frequency sweep information frame; receiving, by positioning anchor devices, the frequency sweep information frame; sending, by the device to be positioned, a positioning frame on the time-frequency domain resource block specified by the time-frequency domain resource indication information; receiving, by the positioning anchor devices having received the frequency sweep information frame, the positioning frame on the time-frequency domain resource block specified by the time-frequency domain resource indication information, and determining, according to the positioning frame, CSI information between each positioning anchor device having received the frequency sweep information frame and the device to be positioned; and determining, according to the CSI information, the location of the device to be positioned. The present disclosure can achieve higher-precision Wi-Fi positioning with reduced cost and complexity.

### CROSS-REFERENCE TO RELATED APPLICATIONS

This application is the U.S. National Phase Application under 35 U.S.C. § 371 of International Patent Application No. PCT/CN2022/102585 filed on Jun. 30, 2022, which claims priority to Chinese Patent Application CN202110748377.5 filed on Jun. 20, 2021. The disclosures of the aforementioned applications are hereby incorporated by reference in their entireties.

### TECHNICAL FIELD

The present disclosure relates to wireless positioning technologies, and in particular to a Wi-Fi positioning method and system.

### TECHNICAL FIELD

In the past decades, indoor positioning technologies have been extensively studied, and the large-scale popularization of smartphones and wearable devices with wireless communication capabilities has made the positioning and tracking of such devices synonymous with the positioning and tracking of corresponding users, and has enabled a wide range of related applications and services, and the positioning of users and devices has been widely applied in the health sector, industries, disaster management, building management, monitoring and many other fields. Specifically, indoor positioning mainly utilizes Wi-Fi, Bluetooth, UWB, LoRA, ultrasonic, infrared and other signals. The technical means used for positioning mainly include RSSI, AoA, ToA/TDoA, Wi-Fi Fingerprint, etc.

However, in outdoor Internet of Things (IoT) application scenarios, especially in large-scale outdoor IoT applications such as pastures, farms, orchards, factories, ports, etc., existing indoor/outdoor positioning means still have obvious deficiencies. On the one hand, existing outdoor positioning mainly utilizes GPS signals, but GPS positioning accuracy is low, which cannot meet the needs of outdoor IoT applications. Moreover, GPS positioning modules usually solely support positioning functions. In applications where GPS combines with IoT, two modules, i.e., a GPS positioning module and an IoT module, are required to be provided in the IoT device, which unnecessarily increases the complexity of the IoT positioning system as well as the deployment and maintenance costs thereof.

On the other hand, currently existing indoor positioning/ranging technologies still have various shortcomings for outdoor IoT applications. UWB technology has high positioning accuracy, but has high hardware requirements and supports few terminals and anchor points. Wi-Fi based positioning/ranging technology is a hot topic of research, but existing solutions cannot achieve a good compromise in terms of accuracy/complexity/real-time performance: some existing high-precision Wi-Fi positioning/ranging solutions have high complexity and poor real-time performance; while some simple Wi-Fi positioning/ranging solutions have very low accuracy. Existing Wi-Fi positioning technologies perform ranging through standard Wi-Fi protocols, which results in sending more redundant information during channel scanning and longer scanning cycles, and thus inefficient.

In addition, the inventors of this disclosure also note that these existing positioning technologies tend to focus on positioning a target/terminal by means of a few or one anchor device, which requires high ranging/directional accuracy for a single anchor device, and the measurement/calculation load of the single anchor device is also large. For outdoor IoT positioning systems with many anchor devices, it is especially an impediment to technical implementation and deployment and maintenance costs.

To sum up, there is a need in the prior art for an IoT positioning system and method, such as a Wi-Fi positioning system and method, which can complete higher-precision positioning (especially outdoor positioning) with reduced cost and technical complexity to solve at least the above problems existing in the prior art. It should be understood that the above technical problems are only examples and not limitations of the present disclosure. The present disclosure is not limited to the technical solution that simultaneously solves all the above technical problems. The technical solution of the present disclosure can be implemented to solve one or more of the above or other technical problems.

### SUMMARY OF THE INVENTION

In response to the above problems, it is an object of the present disclosure to provide a Wi-Fi positioning system and method, which can achieve higher-precision positioning with reduced cost and technical complexity.

In one aspect of the present disclosure, a method for Wi-Fi positioning in a Wi-Fi network is provided. The Wi-Fi network comprises a plurality of positioning anchor devices and at least one device to be positioned, wherein the plurality of anchor devices comprise at least one access point device and at least one site device, and the method includes: generating and sending, by one of the at least one access point device, a channel status indication frame indicating a current channel status; receiving, by one of the at least one device to be positioned, the channel status indication frame; generating, by the device to be positioned having received the channel status indication frame, a frequency sweep information frame according to the current channel status indicated by the channel status indication frame, the frequency sweep information frame comprising time-frequency domain resource indication information, wherein the time-frequency domain resource indication information specifies one or more time-frequency domain resource blocks; sending, by the device to be positioned having received the channel status indication frame, the frequency sweep information frame; receiving, by one or more positioning anchor devices among the plurality of positioning anchor devices, the frequency sweep information frame; sending, by the device to be positioned having received the channel status indication frame, one or more positioning frames on one or more time-frequency domain resource blocks specified by the time-frequency domain resource indication information; receiving, by one or more positioning anchor devices having received the frequency sweep information frame, the one or more positioning frames on one or more time-frequency domain resource blocks specified by the time-frequency domain resource indication information, and determining, according to the one or more positioning frames, CSI information between each positioning anchor device having received the frequency sweep information frame and the device to be positioned having received the channel status indication frame; and determining, according to the CSI information, the location of the device to be positioned having received the frequency sweep information frame.

Optionally, the time-frequency domain resource indication information is carried in a PHY and/or MAC header field of the frequency sweep information frame.

Optionally, the time-frequency domain resource indication information is carried in one or more of a reserved field, a user-defined field, a custom frame structure and a bit mapping of the frequency sweep information frame.

Optionally, the one or more positioning anchor devices are located within a Wi-Fi signal transmission range of the device to be positioned having received the channel status indication frame.

Optionally, the one or more positioning anchor devices are all positioning anchor devices located within the Wi-Fi signal transmission range of the device to be positioned having received the channel status indication frame and capable of Wi-Fi communication with the device to be positioned.

Optionally, the step of determining, according to the one or more positioning frames, CSI information between each positioning anchor device having received the frequency sweep information frame and the device to be positioned having received the channel status indication frame includes: performing, by each positioning anchor device having received the frequency sweep information frame, CSI splicing according to the one or more positioning frames to obtain CSI information between the positioning anchor device and the device to be positioned having received the channel status indication frame.

Optionally, the step of determining the location of the device to be positioned having received the frequency sweep information frame according to the CSI information includes: each positioning anchor device having received the frequency sweep information frame, according to the CSI information, determines a distance between the positioning anchor device and the device to be positioned having received the channel status indication frame, and aggregates the distance to one of the at least one access point device or a server located within or outside the Wi-Fi network to determine the location of the device to be positioned. Optionally, the device to be positioned having received the channel status indication frame sends a CTS frame prior to sending the one or more positioning frames.

In another aspect of the present disclosure, a method for Wi-Fi positioning in a Wi-Fi network is provided. The Wi-Fi network comprises a plurality of positioning anchor devices and at least one device to be positioned, wherein the plurality of anchor devices comprises at least one access point device and at least one site device, and the method includes: sending, by one of the at least one access point device, a frequency sweep indication frame, wherein the frequency sweep indication frame comprises time-frequency domain resource indication information, the time-frequency domain resource indication information specifies one or more time-frequency domain resource blocks; receiving, by one of the at least one device to be positioned, the frequency sweep indication frame; receiving, by one or more positioning anchor devices among the plurality of positioning anchor devices, the frequency sweep indication frame; sending, by the device to be positioned having received the frequency sweep indication frame, one or more positioning frames on one or more time-frequency domain resource blocks specified by the time-frequency domain resource indication information; receiving, by one or more positioning anchor devices having received the frequency sweep indication frame, the one or more positioning frames on one or more time-frequency domain resource blocks specified by the time-frequency domain resource indication information, and determining, according to the one or more positioning frames, CSI information between each positioning anchor device having received the frequency sweep indication frame and the device to be positioned having received the frequency sweep indication frame; and determining, according to the CSI information, the location of the device to be positioned having received the frequency sweep indication frame.

Optionally, the time-frequency domain resource indication information is carried in a PHY and/or MAC header field of the frequency sweep indication frame.

Optionally, the time-frequency domain resource indication information is carried in one or more of a reserved field, a user-defined field, a customized frame structure and a bit mapping of the frequency sweep indication frame.

Optionally, the frequency sweep indication frame is a trigger frame.

Optionally, the one or more positioning anchor devices are located within a signal transmission range of the device to be positioned having received the frequency sweep indication frame.

Optionally, the one or more positioning anchor devices are all positioning anchor devices located within a Wi-Fi signal transmission range of the device to be positioned having received the frequency sweep indication frame and capable of Wi-Fi communication with the device to be positioned.

Optionally, one of the at least one access point device sends a frequency sweep indication frame to one or more of the at least one device to be positioned, and one or more of the at least one site device receives the frequency sweep indication frame by listening.

Optionally, the step of determining, according to the one or more positioning frames, CSI information between each positioning anchor device having received the frequency sweep indication frame and the device to be positioned having received the frequency sweep indication frame includes: performing, by each positioning anchor device having received the frequency sweep indication frame, CSI splicing according to the one or more positioning frames to obtain CSI information between the positioning anchor devices and the device to be positioned having received the frequency sweep indication frame.

Optionally, the step of determining the location of the device to be positioned having received the frequency sweep indication frame according to the CSI information includes: determining, by each positioning anchor device having received the frequency sweep indication frame, according to the CSI information, at least one distance between the positioning anchor devices and the device to be positioned having received the frequency sweep indication frame, and aggregating the at least one distance to one of the at least one access point device or a server located within or outside the Wi-Fi network to determine the location of the device to be positioned.

Optionally, the device to be positioned having received the frequency sweep indication frame sends a CTS frame prior to sending the one or more positioning frames.

In the method for Wi-Fi positioning in a Wi-Fi network according to the above aspect of the present disclosure, further optionally, the plurality of positioning anchor devices further comprise one or more devices to be positioned of which locations have been determined.

Further optionally, the time-frequency domain resource indication information comprises a plurality of frequency points and time-domain intervals between and within the frequency points.

Further optionally, the time-frequency domain resource indication information further comprises the number of times of retransmission.

Further optionally, the time-frequency domain resource indication information comprises encoded information of the one or more time-frequency domain resource blocks.

Further optionally, the positioning frame does not comprise a load.

Further optionally, the positioning frame comprises an HE-LTF field in the PHY header.

Further optionally, the plurality of positioning anchor devices and at least one device to be positioned form a tree Wi-Fi Mesh network, wherein the at least one access point device forms a root node and intermediate nodes of the tree Wi-Fi Mesh network, and the at least one site device and the at least one device to be positioned form leaf nodes of the tree Wi-Fi Mesh network.

Further optionally, each of the at least one access point device is an AP device or an SoftAP device.

In yet another aspect of the present disclosure, a Wi-Fi positioning system is provided, comprising:
a plurality of positioning anchor devices and at least one device to be positioned forming a Wi-Fi network, wherein the plurality of anchor devices comprise at least one access point device and at least one site device;

wherein the Wi-Fi positioning system is configured to perform one or more Wi-Fi positioning methods according to embodiments of the present disclosure.

Optionally, each of the at least one device to be positioned has lower computational power and lower power consumption than each of the at least one site device.

Optionally, each of the at least one site device and the at least one device to be positioned is a single-antenna device.

Compared with existing Wi-Fi positioning solutions, the advantages of the present disclosure include but are not limited to:
(1) improving scanning efficiency through a proprietary protocol-based channel scanning mechanism;
(2) saving time-frequency domain resources;
(3) reducing power consumption of devices to be positioned and site devices;
(4) improving precision of CSI estimation; and
(5) completing higher-precision Wi-Fi positioning with reduced cost and technical complexity.

It should be understood that the present disclosure is not limited to the technical solution that simultaneously provides the above advantages. The technical solution of the present disclosure can be implemented to provide one or more of the above or other advantages. It should also be understood that the above description of the background art and the summary of the disclosure are illustrative only and not restrictive.

### BRIEF DESCRIPTION OF THE DRAWINGS

FIG. 1 illustrates a schematic block diagram of a Wi-Fi positioning system according to an embodiment of the present disclosure.

FIG. 2 illustrates a schematic flow chart of a method for Wi-Fi positioning in a Wi-Fi network according to the first embodiment of the present disclosure.

FIG. 3 illustrates a schematic block diagram of a time-frequency domain resource block specified by time-frequency domain resource indication information in an embodiment according to the present disclosure.

FIG. 4 illustrates a schematic block diagram of a frequency sweep information frame and/or a frequency sweep indication frame in an embodiment according to the present disclosure.

FIG. 5 illustrates a method for Wi-Fi positioning in a Wi-Fi network according to the second embodiment of the present disclosure.

### DETAILED DESCRIPTION OF THE PREFERRED EMBODIMENTS

The present disclosure will be described more thoroughly hereinafter with reference to the drawings which form a part of the present disclosure and illustrate exemplary embodiments by way of illustration. It should be understood that the embodiments shown in the drawings and described hereinafter are merely illustrative and not intended to limit the present disclosure.

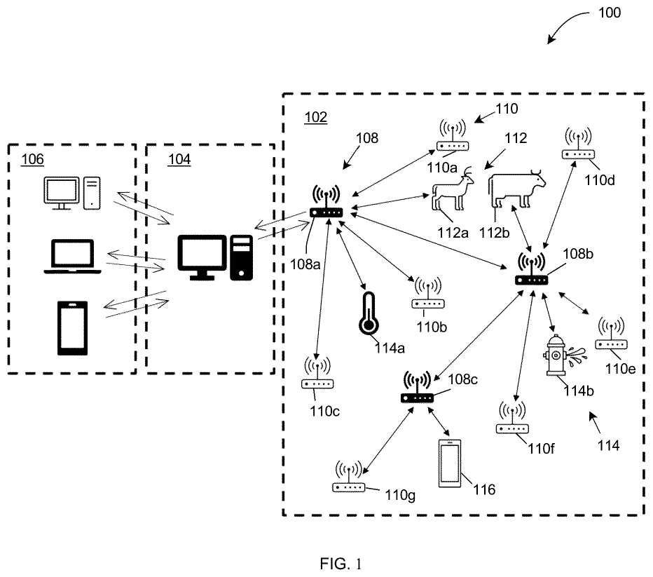

FIG. 1 illustrates a schematic block diagram of a Wi-Fi positioning system 100 according to an embodiment of the present disclosure. As shown, the Wi-Fi positioning system 100 comprises a plurality of positioning anchor devices and a plurality of devices to be positioned 112a, 112b (collectively referred to as the devices to be positioned 112) forming a Wi-Fi network 102. The positioning anchor devices and the devices to be positioned may for example be interconnected via a Mesh ad-hoc network or network cables. The anchor devices comprise access point devices 108a, 108b, and 108c (collectively referred to as the access point devices 108) and site devices 110a, 110b, . . . , 110g (collectively referred to as the site devices 110). For ease of description, in this disclosure, the access point device may be referred to as an AP/SoftAP device, and the site device may be a Wi-Fi site device, referred to as an STA device. The access point device may be an AP device or an SoftAP device, which on the one hand can serve as an AP/Soft AP to provide Internet services or network access relays to other STA devices, and on the other hand can also serve as a positioning anchor to provide positioning services for other IoT devices. The STA device can serve as a positioning anchor to provide positioning services for other IoT devices.

The device to be positioned may be referred to as a TAG device in this disclosure. The TAG device may work as an STA or comprise at least one STA, communicate with the AP/SoftAP and access external networks via the AP/SoftAP. The TAG device shown in FIG. 1 comprises devices to be positioned 112a and 112b worn by or configured for animals or other moving living creatures/objects in the breeding/pastoral region shown. As a non-limiting example, a wearable device can be worn on a living creature that needs to be positioned, which includes several sensors and TAG devices or STA devices for positioning and living creature monitoring data transmission. Although FIG. 1 shows that the Wi-Fi positioning system of the present disclosure is configured for breeding/pastoral regions, embodiments of the present disclosure are not limited thereto. Those skilled in the art should understand that the Wi-Fi positioning system of the present disclosure can be used in various IoT applications, such as pastures, farms, orchards, factories, ports and other outdoor IoT applications.

In the illustrative embodiment shown in FIG. 1, the positioning anchor device and the device to be positioned form a tree Wi-Fi Mesh network, in which the access point devices 108 form a root node and intermediate nodes of the tree Wi-Fi Mesh network. The site devices 110 and the devices to be positioned 112 form leaf nodes of the tree Wi-Fi Mesh network.

It should be understood that in the present disclosure, the roles of the anchor device and the device to be positioned can be converted to each other. For example, one or more devices to be positioned of which locations have been determined can serve as anchor devices to assist in the positioning of other TAG devices. In addition, those skilled in the art should understand that the roles of the SoftAP device and the STA device can also be switched. For example, a Wi-Fi device with SoftAP and STA functions turned on simultaneously may serve as an access point device in the solution of the present disclosure, and the same device with the SoftAP function turned off may serve as an anchor device or TAG device in the solution of the present disclosure. In addition, the mobile phone 116 or other devices that need to be networked, such as a temperature sensor 114a, a fire hydrant 114b, etc., carried by livestock farm personnel may access the Wi-Fi network of the present disclosure for Wi-Fi network communication, and may serve as an access point device, STA device or TAG device as needed or configured.

In one embodiment, each of the devices to be positioned 112 has lower computational capabilities and lower power consumption than each of the site devices 110. As a non-limiting example, the device to be positioned may be a low-power IoT device powered by a battery and miniaturized to facilitate tracking of living creatures/objects. The site device may be relatively stationary and therefore powered by larger capacity batteries, or via AC power or solar panels, for example. In particular, each of the site devices and the devices to be positioned may be implemented as a single-antenna device. In this way, the Wi-Fi positioning system of the present disclosure can be implemented in a cost-effective manner, using low-cost devices to complete the functions of Wi-Fi network communication and Wi-Fi positioning without the need to additionally configure a GPS module on the device to be positioned, or using a large number of expensive, high-performance AP devices as anchor devices.

The Wi-Fi network in the Wi-Fi positioning system 100 of the present disclosure may be communicatively connected to a server 104, such as a server deployed locally or in the cloud. The server may provide higher computational performance as well as back-end management functions for the Wi-Fi positioning system of the present disclosure. For example, users may access the server via different remote terminals 106 to access and manage the Wi-Fi positioning system 100 of the present disclosure. It should be understood that the implementation of the present disclosure is not limited thereto. The Wi-Fi positioning system of the present disclosure may be implemented to comprise or not comprise a server, and users may access and manage the Wi-Fi positioning system of the present disclosure via a local terminal accessing the Wi-Fi positioning system, such as the mobile phone 116.

In embodiments of the present disclosure, a signal may be transmitted by the device to be positioned using a preset transmit time-frequency domain signal pattern, and the positioning anchor point obtains CSI from the received signal and utilizes the CSI for positioning.

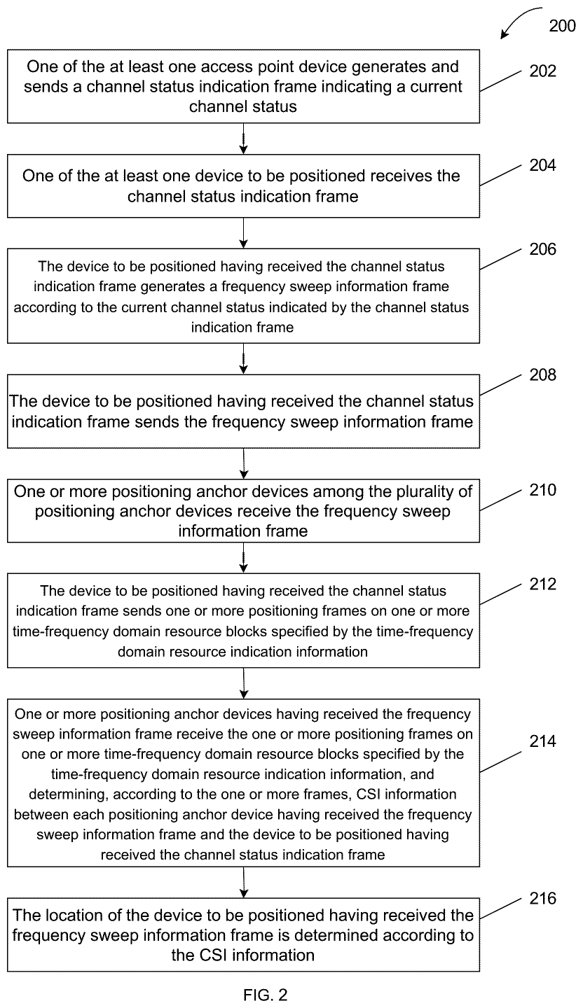

FIG. 2 illustrates a schematic flow chart of a method for Wi-Fi positioning in a Wi-Fi network according to the first embodiment of the present disclosure. The Wi-Fi network may comprise a plurality of positioning anchor devices and at least one device to be positioned, wherein the plurality of anchor devices comprise at least one access point device and at least one site device. By way of example and not limitation, the Wi-Fi network may be implemented as the Wi-Fi network 102 shown in FIG. 1.

In step 202, one of the at least one access point device generates and sends a channel status indication frame indicating a current channel status. In step 204, one of the at least one device to be positioned receives the channel status indication frame. For example, the access point device may carry available frequency point information by broadcasting a trigger frame or beacon frame, and the device to be positioned may obtain channel status information by receiving the trigger frame or beacon frame. In this way, the power-constrained device to be positioned (TAG device) does not need to consume limited battery power to acquire channel status (such as available frequency points) and thus obtain extended standby and working times.

In step 206, the device to be positioned having received the channel status indication frame generates a frequency sweep information frame according to the current channel status indicated by the channel status indication frame, the frequency sweep information frame comprises a time-frequency domain resource indication information, wherein the time-frequency domain resource indication information specifies one or more time-frequency domain resource blocks.

In step 208, the device to be positioned having received the channel status indication frame sends the frequency sweep information frame.

In step 210, one or more positioning anchor devices among the plurality of positioning anchor devices receive the frequency sweep information frame.

In step 212, the device to be positioned having received the channel status indication frame sends one or more positioning frames on one or more time-frequency domain resource blocks specified by the time-frequency domain resource indication information. As a non-limiting example, the positioning frame may be sent at the MAC layer or the physical layer.

In step 214, one or more positioning anchor devices having received the frequency sweep information frame receive the one or more positioning frames on one or more time-frequency domain resource blocks specified by the time-frequency domain resource indication information, and determine, according to the one or more positioning frames, CSI information between each positioning anchor device having received the frequency sweep information frame and the device to be positioned having received the channel status indication frame.

In step 216, the location of the device to be positioned having received the frequency sweep information frame is determined according to the CSI information.

The present disclosure, through a proprietary protocol-based channel scanning mechanism, can improve scanning efficiency, save time-frequency domain resources, reduce power consumption of devices to be positioned and site devices, and improve precision of CSI estimation.

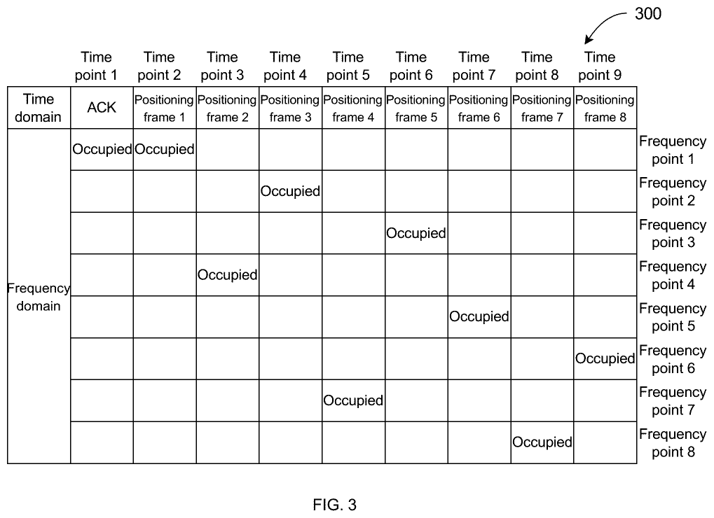

FIG. 3 illustrates a schematic block diagram of a time-frequency domain resource block specified by time-frequency domain resource indication information in an embodiment according to the present disclosure. In the block diagram shown in FIG. 3, the horizontal axis represents time intervals in the time domain, the vertical axis represents frequency points in the frequency domain, and each grid on the horizontal and vertical intersections represents a time-frequency domain resource. It should be understood that the frequency hopping method does not have to be as shown in FIG. 3, and different frames may partially overlap in the frequency domain. By way of example and not limitation, in FIG. 3, a grid represents 20M in the frequency domain; blank ones are respective free; “occupied” indicates that the time-frequency domain resource block is occupied.

According to the time-frequency domain resource blocks specified by the time-frequency domain resource indication information, the TAG device may perform multiple frequency point switching when sending positioning frames, thereby sending positioning frames over a larger bandwidth than data communication. In this way, after receiving the time-frequency domain resource indication information, the positioning anchor devices (site devices and/or access point devices) may receive positioning packets subsequently sent by the TAG device on the specified time-frequency domain resource. Each packet received by the positioning anchor devices from the TAG device can be used to acquire corresponding CSI information, including but not limited to channel estimation over each subcarrier in the frequency domain. Then, the positioning anchor devices may perform CSI splicing according to the positioning packets to obtain CSI information. Furthermore, the positioning anchor devices may use known or future developed methods to acquire distance information between the positioning anchor devices and the TAG device according to the CSI information.

In embodiments of the present disclosure, the device to be positioned may select time-frequency domain resource indication information according to available frequency point information, where the time-frequency domain resource indication information may comprise a plurality of frequency points and time-domain intervals between and within the frequency points. Furthermore, the time-frequency domain resource indication information may also comprise the number of times of retransmission.

It should be understood that the time-frequency domain resource indication information may comprise information directly indicative of one or more time-frequency domain resource blocks, such as frequency points and time domain intervals between and within the frequency points, and may also comprise encoded information for one or more time-frequency domain resource blocks. In this way, the sender and receiver of the time-frequency domain resource indication information may generate the encoded information of the time-frequency domain resource block according to the agreed encoding method, and decode the encoded information of the time-frequency domain resource block according to the agreed decoding method, thereby improving transmission efficiency.

As a non-limiting example, the TAG device may enter the positioning mode through the type/subtype field in the frequency sweep information frame, that is, sending the specified time-frequency domain resource indication information to the anchor device for Wi-Fi positioning.

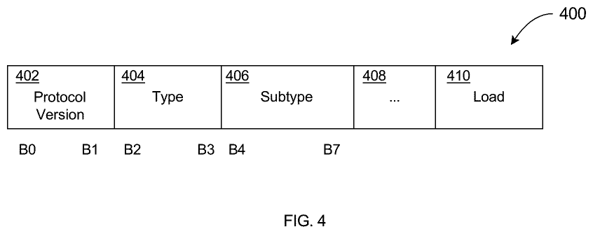

In embodiments of the present disclosure, the time-frequency domain resource indication information may be carried in a PHY and/or MAC header field of the frequency sweep information frame. For example, an example structure of the frequency sweep information frame is shown in FIG. 4. FIG. 4 illustrates a schematic block diagram of a frequency sweep information frame and/or a frequency sweep indication frame (collectively referred to as a “frequency sweep frame”) in an embodiment according to the present disclosure.

In the example shown in FIG. 4, the header of the frequency sweep frame comprises a “Protocol Version” field 402 of two bytes B0 through B1, a “Type” field 402 of two bytes B2 through B3, and a “Subtype” field of four bytes B4 through B7, which are MAC frame control and sequence control fields of the Wi-Fi protocol shown below. The “Load” field 410 may carry time-frequency domain resource indication information according to the present disclosure.

In the protocol, the bit mapping of the “Type” field and the meaning thereof are shown in the following table:

| Type | Type description |
|---|---|
| 00 | Management |
| 01 | Control |
| 10 | Data |
| 11 | — |

When the value of the “Type” field is 10 (data frame), the bit mapping of the “Subtype” field and the meaning thereof are shown in the following table:

| Subtype | Subtype description |
|---|---|
| 0000 | Data |
| . . . | . . . |
| 1100 | QoS null value (no data) |
| 1101 | Reserve |
| 1110 | QOS CF-Polling (no data) |
| 1111 | QOS CF-Ack + CF-Poll (no data) |

In the Wi-Fi protocol, when the value of the “Type” field is 10, the value of the “Subtype” field of 1101 is reserved. Based on this, in embodiments of the present disclosure, the proprietary protocol followed by TAG, STA and AP/SoftAP may be defined such that the “subtype” field of 1101 represents a frequency sweep frame, and the meanings of other fields of the frequency sweep frame are the same as those of the data frame (the value of “Subtype” field is 0000). Sweep frames may and should be generated, sent and received, and processed between the TAG, the STA, and the AP/SoftAP in the agreed manner. It should be noted that the load in the MAC PDU of the frequency sweep frame has a special meaning and may carry time-frequency domain resource indication information, that is, the time-frequency domain resource used by the scanning channel when the TAG sends a positioning frame indicated by the content in the load. After receiving the frequency sweep frame, the TAG responds to ACK and then starts channel scanning. In a non-limiting embodiment of the present disclosure, when the value of “Type” field is 10 and the value of the “Subtype” field is 1101, if the bit sequence in the load matches a predetermined sequence (such as 8-bit 0×FF), then it may represent turning off the scanning mode of the TAG, and the TAG turns off the scanning mode upon receipt of the packet, and the STA performs ranging on the TAG according to the acquired CSI upon receipt of the packet.

By way of example and not limitation, when indicating time-frequency domain resources, the signal representation mode of the data bits in the bit sequence may be that one frequency point is indicated by 8 bits, so that the N frequency points are a total of NX8 bits (N being the number of frequency points), and the 8 bits may indicate a channel number. The correspondence between channel numbers and frequencies may be customized according to standard Wi-Fi protocols or proprietary protocols. The following table shows an example of the correspondence between channel numbers and frequencies, wherein the frequency hopping sequence of channel scanning is the same as the sequence of the N×8 bits. After receiving the control frame and feeding back the ACK, the TAG performs channel scanning according to the indicated packet instruction information.

| Channel | Frequency |
|---|---|
| number | (MHz) |
| 1 | 2412 |
| 2 | 2417 |
| . . . | . . . |
| 36 | 5180 |
| . . . | . . . |
| 149 | 5735 |
| . . . | . . . |

Those skilled in the art should understand that the above are only non-limiting examples of the representation and carrying methods of the time-frequency domain resource indication information, and that the implementation of the present disclosure is not limited thereto. On the contrary, the time-frequency domain resource indication information may be carried in one or more of a reserved domain, a user-defined field, a custom frame structure and a bit mapping of the frequency sweep information frame.

According to embodiments of the present disclosure, the time-frequency domain resource indication information may be transmitted via reserved bits or unused bit mapping in the PHY and MAC packet headers, controlling the time-frequency domain resource used by the TAG packet. The access point device or TAG device can inform the TAG device of the number of frequency hopping and the frequency used according to the channel status indication. The time-frequency domain resource indication information of the access point device or TAG device may also be parsed by the STA device, thereby receiving the TAG packet at the corresponding frequency point for positioning. None of the above methods requires additional overhead such as control frames, further improving the efficiency of channel scanning. The receiving end performs receiving processing in the corresponding time-frequency domain resource to acquire CSI, and the receiving end can perform CSI splicing to obtain distance information for positioning.

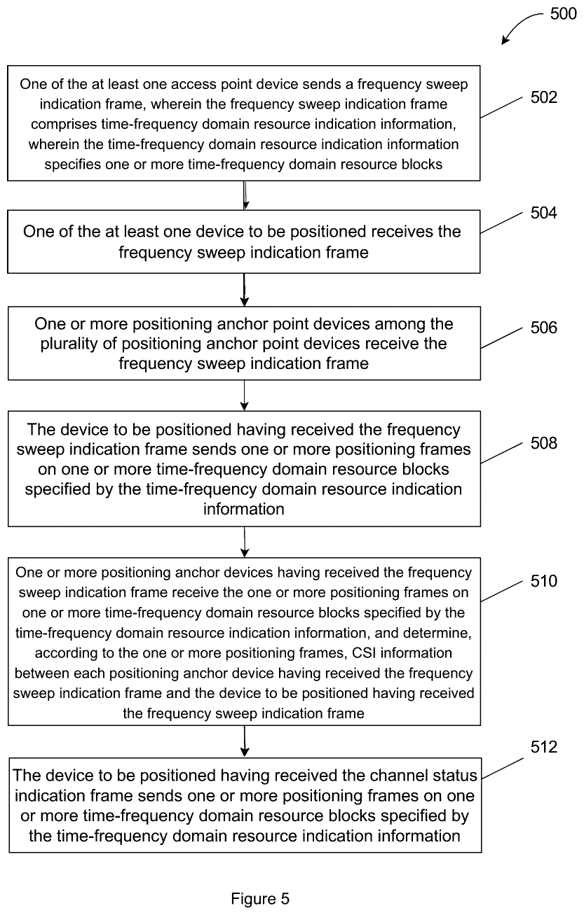

FIG. 5 illustrates a method for Wi-Fi positioning in a Wi-Fi network according to the second embodiment of the present disclosure. The Wi-Fi network comprises a plurality of positioning anchor devices and at least one device to be positioned, wherein the plurality of anchor devices comprise at least one access point device and at least one site device. By way of example and not limitation, the Wi-Fi network may be implemented as the Wi-Fi network 102 shown in FIG. 1.

In step 502, one of the at least one access point device sends a frequency sweep indication frame, wherein the frequency sweep indication frame comprises time-frequency domain resource indication information, wherein the time-frequency domain resource indication information specifies one or more time-frequency domain resource blocks.

In step 504, one of the at least one device to be positioned receives the frequency sweep indication frame.

In step 506, one or more positioning anchor point devices among the plurality of positioning anchor point devices receive the frequency sweep indication frame.

In step 508, the device to be positioned having received the frequency sweep indication frame sends one or more positioning frames on one or more time-frequency domain resource blocks specified by the time-frequency domain resource indication information.

In step 510, one or more positioning anchor devices having received the frequency sweep indication frame receive the one or more positioning frames on one or more time-frequency domain resource blocks specified by the time-frequency domain resource indication information, and determine, according to the one or more positioning frames, CSI information between each positioning anchor device having received the frequency sweep indication frame and the device to be positioned having received the frequency sweep indication frame.

In step 512, the location of the device to be positioned having received the frequency sweep indication frame is determined according to the CSI information.

It should be understood that the difference between the solution according to the second embodiment and the solution according to the first embodiment mainly lies in that in the first embodiment, the TAG device, through the frequency sweep information frame, specifies the time-frequency domain resource for the TAG to send the positioning frame, and in the second embodiment, the access point device (AP or SoftAP), through the frequency sweep indication frame, specifies the time-frequency domain resources for the TAG to send the positioning frame. Therefore, the same or similar aspects in the two embodiments will not be repeated herein.

In this embodiment, the format of the frequency sweep information frame sent by the TAG to the STA may be the same as the format of the frequency sweep indication frame of the SoftAP controlling TAG packet, as described above with respect to the first embodiment.

For example, the time-frequency domain resource indication information may comprise multiple frequency points and time-domain intervals between and within the frequency points. The time-frequency domain resource indication information may also comprise the number of times of retransmission. The time-frequency domain resource indication information may comprise encoded information of the one or more time-frequency domain resource blocks.

In embodiments of the present disclosure, the time-frequency domain resource indication information may be carried in a PHY and/or MAC header field of the frequency sweep indication frame. The time-frequency domain resource indication information may be carried in one or more of a reserved field, a user-defined field, a customized frame structure and a bit mapping of the frequency sweep indication frame.

In addition, the frequency sweep indication frame may be a trigger frame. In this way, information positioned according to the proprietary protocol may be added to the standard frame sent by the access point device according to the Wi-Fi protocol, thereby extending the positioning function of the Wi-Fi device in the solution of the present disclosure while maintaining compatibility with the standard protocol.

However, the implementation of the present disclosure is not limited thereto. Those skilled in the art may use the same or different formats for the frequency sweep information frame and the frequency sweep indication frame without departing from the principles of the present disclosure.

In the first embodiment of the present disclosure, there is no need to feed back ACK for frames (i.e., frequency sweep information frames) sent by the TAG device for channel scanning. In the second embodiment of the present disclosure, the frames (i.e., frequency sweep indication frames) sent by the SoftAP to control the TAG to perform channel scanning requires the TAG to feed back ACK to ensure that the control information is delivered correctly. For data transmission business packets, the ACK is fed back normally.

For the first and second embodiments of the present disclosure, a positioning frame may not comprise a load. Further, the positioning frame may comprise the HE-LTF field in the PHY header. In this way, Wi-Fi positioning may be performed based on the header field of the physical layer positioning frame without consuming computational resources and time to parse the load of the positioning frame.

In addition, the packet (i.e. frequency scanning indication frame) for channel scanning (frequency hopping) of the TAG device may also only use the HT/VHT/HE-LTF field of the preamble in the PHY for channel estimation, thus allowing the use of no-load packets similar to an NDP (Non-data packet) to save time resources.

The preamble in a regular physical layer packet will comprise the HE-LTF field based on which the receiver may perform channel estimation.

It should be understood that in a tree Wi-Fi Mesh network, site devices cannot directly communicate with each other, and need to be forwarded via the access point device AP/SoftAP, but the positioning method and system of the present disclosure are not limited by this. In embodiments of the present disclosure, all positioning anchor devices within the Wi-Fi signal transmission range of the TAG device may participate in the positioning of the TAG device. Furthermore, positioning anchor devices positioned within the Wi-Fi signal transmission range of the TAG device and capable of Wi-Fi communication with the device to be positioned may be involved in the positioning of the TAG device.

In embodiments of the present disclosure, the step of determining, according to the one or more positioning frames, CSI information between each positioning anchor device having received the frequency sweep information frame and the device to be positioned having received the channel status indication frame includes: each positioning anchor device having received the frequency sweep information frame performs CSI splicing according to the one or more positioning frames to obtain CSI information between the positioning anchor device and the device to be positioned having received the channel status indication frame.

In an embodiment of the present disclosure, the step of determining the location of the device to be positioned having received the frequency sweep information frame according to the CSI information includes: each positioning anchor device having received the frequency sweep information frame, according to the CSI information, determines at least one distance between the positioning anchor devices and the device to be positioned having received the channel status indication frame, and aggregates the at least one distance to one of the at least one access point device or a server located within or outside the Wi-Fi network to determine the location of the device to be positioned.

In embodiments of the present disclosure, the device to be positioned having received the channel status indication frame may send a CTS frame before sending the one or more positioning frames. In this way, before sending the positioning frame, the TAG device may send CTS information (including time information). The device having received the CTS information will not perform sending operation within a specified time, avoiding packet collision with other devices in the MESH network when the TAG sends the positioning frame, thus helping to improve the accuracy of Wi-Fi positioning according to the solution of the present disclosure.

While various embodiments of various aspects of the disclosure have been described for the purpose of this disclosure, it shall not be understood that the teaching of this disclosure is limited to these embodiments. The features disclosed in a specific embodiment are therefore not limited to that embodiment, but may be combined with the features disclosed in different embodiments. For example, one or more features and/or operations of the system or method according to the present disclosure described in one embodiment may also be applied individually, in combination, or as a whole in another embodiment. Furthermore, it should be understood that the method steps described above may be performed sequentially, performed in parallel, combined into fewer steps, split into more steps, combined in a different manner than described and/or omitted. Those skilled in the art will understand that there are more possible optional implementations and modifications, and various changes and modifications may be made to the above method steps, without departing from the scope defined by the claims of the present disclosure.

1. A method for Wi-Fi positioning in a Wi-Fi network comprising a plurality of positioning anchor devices and at least one device to be positioned, wherein the plurality of anchor devices comprise at least one access point device and at least one site device, the method includes:
generating and sending, by one of the at least one access point device, a channel status indication frame indicating a current channel status;
receiving, by one of the at least one device to be positioned, the channel status indication frame;
generating, by the device to be positioned having received the channel status indication frame, a frequency sweep information frame according to the current channel status indicated by the channel status indication frame, the frequency sweep information frame comprising time-frequency domain resource indication information, wherein the time-frequency domain resource indication information specifies one or more time-frequency domain resource blocks;
sending, by the device to be positioned having received the channel status indication frame, the frequency sweep information frame;
receiving, by one or more positioning anchor devices among the plurality of positioning anchor devices, the frequency sweep information frame;
sending, by the device to be positioned having received the channel status indication frame, one or more positioning frames on one or more time-frequency domain resource blocks specified by the time-frequency domain resource indication information;
receiving, by one or more positioning anchor devices having received the frequency sweep information frame, the one or more positioning frames on one or more time-frequency domain resource blocks specified by the time-frequency domain resource indication information, and determining, according to the one or more positioning frames, CSI information between each positioning anchor device having received the frequency sweep information frame and the device to be positioned having received the channel status indication frame; and
determining, according to the CSI information, the location of the device to be positioned having received the frequency sweep information frame.

2. The method for Wi-Fi positioning in a Wi-Fi network according to claim 1, wherein the plurality of positioning anchor devices further comprise one or more devices to be positioned of which locations have been determined.

3. The method for Wi-Fi positioning in a Wi-Fi network according to claim 1, wherein the time-frequency domain resource indication information comprises one of:
a plurality of frequency points and time-domain intervals between and within the frequency points; wherein the time-frequency domain resource indication information further comprises the number of times of retransmission; and
encoded information of the one or more time-frequency domain resource blocks.

4. (canceled)

5. (canceled)

6. The method for Wi-Fi positioning in a Wi-Fi network according to claim 1, wherein the time-frequency domain resource indication information is carried in one of:
a PHY and/or MAC header field of the frequency sweep information frame; and
one or more of a reserved field, a user-defined field, a custom frame structure, and a bit mapping of the frequency sweep information frame.

7. (canceled)

8. The method for Wi-Fi positioning in a Wi-Fi network according to claim 1, wherein the positioning frame does not comprise a load; or wherein the positioning frame comprises an HE-LTF field in the PHY header.

9. (canceled)

10. The method for Wi-Fi positioning in a Wi-Fi network according to claim 1, wherein the plurality of positioning anchor devices and at least one device to be positioned form a tree Wi-Fi Mesh network, wherein the at least one access point device forms a root node and intermediate nodes of the tree Wi-Fi Mesh network, and the at least one site device and the at least one device to be positioned form leaf nodes of the tree Wi-Fi Mesh network; and
wherein each of the at least one access point device is an AP device or an SoftAP device.

11. (canceled)

12. The method for Wi-Fi positioning in a Wi-Fi network according to claim 1, wherein the one or more positioning anchor devices are configured as one of:
being located within a Wi-Fi signal transmission range of the device to be positioned having received the channel status indication frame; and
all positioning anchor devices located within the Wi-Fi signal transmission range of the device to be positioned having received the channel status indication frame and capable of Wi-Fi communication with the device to be positioned.

13. (canceled)

14. The method for Wi-Fi positioning in a Wi-Fi network according to claim 1, wherein the step of determining, according to the one or more positioning frames, CSI information between each positioning anchor device having received the frequency sweep information frame and the device to be positioned having received the channel status indication frame includes: performing, by each positioning anchor device having received the frequency sweep information frame, CSI splicing according to the one or more positioning frames to obtain CSI information between the positioning anchor device and the device to be positioned having received the channel status indication frame; wherein the device to be positioned having received the channel status indication frame sends a CTS frame prior to sending the one or more positioning frames; and
the step of determining the location of the device to be positioned having received the frequency sweep information frame according to the CSI information includes: determining, by each positioning anchor device having received the frequency sweep information frame, according to the CSI information, distances between the positioning anchor devices and the device to be positioned having received the channel status indication frame, and aggregating the distances to one of the at least one access point device or a server located within or outside the Wi-Fi network to determine the location of the device to be positioned.

15. (canceled)

16. (canceled)

17. A method for Wi-Fi positioning in a Wi-Fi network comprising a plurality of positioning anchor devices and at least one device to be positioned, wherein the plurality of anchor devices comprises at least one access point device and at least one site device, the method includes:
sending, by one of the at least one access point device, a frequency sweep indication frame, wherein the frequency sweep indication frame comprises time-frequency domain resource indication information, the time-frequency domain resource indication information specifies one or more time-frequency domain resource blocks;
receiving, by one of the at least one device to be positioned, the frequency sweep indication frame;
receiving, by one or more positioning anchor devices among the plurality of positioning anchor devices, the frequency sweep indication frame;
sending, by the device to be positioned having received the frequency sweep indication frame, one or more positioning frames on one or more time-frequency domain resource blocks specified by the time-frequency domain resource indication information;
receiving, by one or more positioning anchor devices having received the frequency sweep indication frame, the one or more positioning frames on one or more time-frequency domain resource blocks specified by the time-frequency domain resource indication information, and determining, according to the one or more positioning frames, CSI information between each positioning anchor device having received the frequency sweep indication frame and the device to be positioned having received the frequency sweep indication frame; and
determining, according to the CSI information, the location of the device to be positioned having received the frequency sweep indication frame.

18. The method for Wi-Fi positioning in a Wi-Fi network according to claim 17, wherein the plurality of positioning anchor devices further comprise one or more devices to be positioned of which locations have been determined.

19. The method for Wi-Fi positioning in a Wi-Fi network according to claim 17, wherein the time-frequency domain resource indication information comprises one of:
a plurality of frequency points and time-domain intervals between and within the frequency points, wherein the time-frequency domain resource indication information further comprises the number of times of retransmission; and
encoded information of the one or more time-frequency domain resource blocks.

20. (canceled)

21. (canceled)

22. The method for Wi-Fi positioning in a Wi-Fi network according to claim 17, wherein the time-frequency domain resource indication information is carried in one of:
a PHY and/or MAC header field of the frequency sweep indication frame; and one or more of a reserved field, a user-defined field, a custom frame structure, and a bit mapping of the frequency sweep indication frame.

23. (canceled)

24. The method for Wi-Fi positioning in a Wi-Fi network according to claim 17, wherein the frequency sweep indication frame is a trigger frame;
wherein the positioning frame does not comprise a load; or
wherein the positioning frame comprises an HE-LTF field in the PHY header.

25. (canceled)

26. (canceled)

27. The method for Wi-Fi positioning in a Wi-Fi network according to claim 17, wherein the plurality of positioning anchor devices and at least one device to be positioned form a tree Wi-Fi Mesh network, wherein the at least one access point device forms a root node and intermediate nodes of the tree Wi-Fi Mesh network, and the at least one site device and the at least one device to be positioned form leaf nodes of the tree Wi-Fi Mesh network; and
wherein each of the at least one access point device is an AP device or an SoftAP device.

28. (canceled)

29. The method for Wi-Fi positioning in a Wi-Fi network according to claim 17, wherein the one or more positioning anchor devices are configured as one of:
being located within a signal transmission range of the device to be positioned having received the frequency sweep indication frame; and
all positioning anchor devices located within a Wi-Fi signal transmission range of the device to be positioned having received the frequency sweep indication frame and capable of Wi-Fi communication with the device to be positioned.

30. (canceled)

31. The method for Wi-Fi positioning in a Wi-Fi network according to claim 17, wherein one of the at least one access point device sends a frequency sweep indication frame to one or more of the at least one device to be positioned, and one or more of the at least one site device receives the frequency sweep indication frame by listening.

32. The method for Wi-Fi positioning in a Wi-Fi network according to claim 17, wherein the step of determining, according to the one or more positioning frames, CSI information between each positioning anchor device having received the frequency sweep indication frame and the device to be positioned having received the frequency sweep indication frame includes: performing, by each positioning anchor device having received the frequency sweep indication frame, CSI splicing according to the one or more positioning frames to obtain CSI information between the positioning anchor device and the device to be positioned having received the frequency sweep indication frame; wherein the device to be positioned having received the frequency sweep indication frame sends a CTS frame prior to sending the one or more positioning frames; and
the step of determining the location of the device to be positioned having received the frequency sweep indication frame according to the CSI information includes: determining, by each positioning anchor device having received the frequency sweep indication frame, according to the CSI information, a distance between the positioning anchor device and the device to be positioned having received the frequency sweep indication frame, and aggregating the distance to one of the at least one access point device or a server located within or outside the Wi-Fi network to determine the location of the device to be positioned.

33. (canceled)

34. (canceled)

35. A Wi-Fi positioning system, comprising:
a plurality of positioning anchor devices and at least one device to be positioned forming a Wi-Fi network, wherein the plurality of anchor devices comprises at least one access point device and at least one site device;
wherein the Wi-Fi positioning system is configured to perform a Wi-Fi positioning method as one of:
(i) generating and sending, by one of the at least one access point device, a channel status indication frame indicating a current channel status;
receiving, by one of the at least one device to be positioned, the channel status indication frame;
generating, by the device to be positioned having received the channel status indication frame, a frequency sweep information frame according to the current channel status indicated by the channel status indication frame, the frequency sweep information frame comprising time-frequency domain resource indication information, wherein the time-frequency domain resource indication information specifies one or more time-frequency domain resource blocks;
sending, by the device to be positioned having received the channel status indication frame, the frequency sweep information frame;
receiving, by one or more positioning anchor devices among the plurality of positioning anchor devices, the frequency sweep information frame;
sending, by the device to be positioned having received the channel status indication frame, one or more positioning frames on one or more time-frequency domain resource blocks specified by the time-frequency domain resource indication information;
receiving, by one or more positioning anchor devices having received the frequency sweep information frame, the one or more positioning frames on one or more time-frequency domain resource blocks specified by the time-frequency domain resource indication information, and determining, according to the one or more positioning frames, CSI information between each positioning anchor device having received the frequency sweep information frame and the device to be positioned having received the channel status indication frame; and
determining, according to the CSI information, the location of the device to be positioned having received the frequency sweep information frame;
(ii) sending, by one of the at least one access point device, a frequency sweep indication frame, wherein the frequency sweep indication frame comprises time-frequency domain resource indication information, the time-frequency domain resource indication information specifies one or more time-frequency domain resource blocks;
receiving, by one of the at least one device to be positioned, the frequency sweep indication frame;
receiving, by one or more positioning anchor devices among the plurality of positioning anchor devices, the frequency sweep indication frame;
sending, by the device to be positioned having received the frequency sweep indication frame, one or more positioning frames on one or more time-frequency domain resource blocks specified by the time-frequency domain resource indication information;
receiving, by one or more positioning anchor devices having received the frequency sweep indication frame, the one or more positioning frames on one or more time-frequency domain resource blocks specified by the time-frequency domain resource indication information, and determining, according to the one or more positioning frames, CSI information between each positioning anchor device having received the frequency sweep indication frame and the device to be positioned having received the frequency sweep indication frame; and
determining, according to the CSI information, the location of the device to be positioned having received the frequency sweep indication frame.

36. The Wi-Fi positioning system according to claim 35, wherein each of the at least one device to be positioned has lower computational power and lower power consumption than each of the at least one site device.

37. The Wi-Fi positioning system according to claim 35, wherein each of the at least one site device and the at least one device to be positioned is a single-antenna device.
